(19) United States
(12) Patent Application Publication
(10) Pub. No.: US 2020/0073206 A1
(43) Pub. Date: Mar. 5, 2020

(54) SYSTEMS AND METHODS FOR GENERATING A HEADSHOT

(71) Applicant: FOGARTY PHOTO, LLC., Henderson, NV (US)

(72) Inventor: Steven J. Fogarty, Henderson, NV (US)

(21) Appl. No.: 16/553,308

(22) Filed: Aug. 28, 2019

Related U.S. Application Data
(60) Provisional application No. 62/723,853, filed on Aug. 28, 2018.
(60) Provisional application No. 62/735,694, filed on Sep. 24, 2018.

(51) Int. Cl. G03B 15/04; G03B 15/06; G01N 21/88; G06K 9/00; G06T 11/60

(52) U.S. Cl. CPC G03B 15/04; G03B 15/06; G06T 11/60; G06K 9/00281; G01N 21/8806

(57) ABSTRACT

A method for generating a headshot can include (i) arranging a diffuse light system by positing a first light source to emit light toward a scattering layer including a white surface such that the emitted light reflects diffusely off of the scattering layer, (ii) positioning a background layer made of translucent material such that diffuse light from the diffuse light system at least partially transmits through the background layer, wherein the background layer has disposed thereon a bokeh background image, and wherein the bokeh background image is illuminated by the diffuse light, (iii) arranging a subject lighting system to illuminate a subject positioned proximate to the background layer, and (iv) capturing a photograph of at least a portion of the subject and the bokeh background image with a camera.

### CROSS REFERENCE TO RELATED APPLICATIONS

This Application claims the benefit of U.S. Provisional Patent Application No. 62/723,853, filed Aug. 28, 2018, and United States Provisional Patent Application No. 62/735,694, filed Sep. 24, 2018, which are incorporated by reference in their entirety.

### BACKGROUND

### 1. Technical Field

The disclosure of this application generally relates to systems and methods for generating a photographic headshot/portrait, and particularly for generating headshots with small-aperture camera systems that convincingly have the appearance of being captured with large-aperture camera systems (e.g., “wide open” cameras and lens) in a visually pleasing real environment.

### 2. Relevant Technology

Professional photographers typically photograph subjects with “wide open” camera systems, using the widest apertures available for their lenses to intentionally blur the background (sometimes referred to as “bokeh” photography). A blurry background is generally viewed as visually pleasing and evidence of professionalism, in particular because “wide open” lenses that allow for large apertures (e.g., f/2.8 or f/2.0 or lower) are relatively expensive. Consumer cameras and lenses typically utilize much smaller apertures, such as f/8 or f/12 apertures (e.g., “closed down” camera systems). The smaller the lens aperture, the more in-focus the background appears, which can distract from the most important part of a portrait—the subject of the portrait.

Capturing a bokeh photograph with a “wide open” camera system can require considerably more time and care than capturing a photograph with a focused background utilizing a “closed down” camera system. If a photographer fails to take the time to find the correct balance between aperture size, focal length, distance between the subject, the camera, and the background, etc., the photographer runs the risk improper focus on the subject of the photograph (e.g., front-focused on the subject's nose or back-focused on the subject's ears).

In view of the foregoing, bokeh photography is typically viewed as impractical for scenarios in which a large number of portraits of multiple subjects will be successively captured (e.g., at a trade show, corporate photography event, or educational institution). This is in part because a photographer would need to allocate a substantial amount of time for each subject to take an effective “wide open” photograph, or else risk rendering the photographs useless by improper focusing.

Furthermore, those skilled in photography typically desire a visually pleasing background for headshots, such as a natural outdoor environment, a majestic building lobby, or a cityscape etc. Such real environments often prove impractical for high-volume photography events for a number of reasons. Requiring subjects to relocate to a desired real environment often requires prohibitive time and expense. Furthermore, real environments are often subject to natural changes in weather and lighting, which can cause difficulty in successively and successfully photographing multiple subjects. Therefore, in high-volume photography events, the available backgrounds are typically limited to simple designs or solid or gradient colors.

In some instances, a large printed backdrop of a visually pleasing environment is utilized. However, such backgrounds often appear fake in finished portraits, particularly to those skilled in the art of photography. In other instances, a green screen setup is utilized, and the photographer manipulates the captured portraits to place the subjects in a visually pleasing environment after capturing the portraits. The computer post-processing necessary for this approach, however, often proves lengthy, and the use of a green screen for portraits is often easily discernible, particularly around the subject's hair.

Accordingly, there exists a need to enable photographers to generate portraits of subjects that convincingly appear to have been captured in visually pleasing real environments with “wide open” camera systems, particularly for high-volume photography engagements.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Disclosed embodiments are directed toward systems and methods for generating a headshot. One exemplary method includes arranging a diffuse light system by positing a first light source to emit light toward a scattering layer including a white surface such that the emitted light reflects diffusely off of the scattering layer. The method also includes positioning a background layer made of translucent material such that diffuse light from the diffuse light system at least partially transmits through the background layer, wherein the background layer has disposed thereon a bokeh background image, and wherein the bokeh background image is illuminated by the diffuse light. Furthermore, a step of arranging a subject lighting system to illuminate a subject positioned proximate to the background layer is included. Finally, the method includes capturing a photograph of at least a portion of the subject and the bokeh background image with a camera.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered limiting in scope, embodiments will be described and explained with additional specificity and detail through the use of the accompanying drawings in which:

FIG. 1 illustrates a schematic representation of an exemplary system for generating a headshot, according to the present disclosure;

FIG. 2 is a photograph that illustrates an exemplary implementation of a system for generating a headshot;

FIG. 3 illustrates a schematic representation of a headshot generated according to at least some embodiments of the present disclosure;

FIG. 4 illustrates an exemplary flow diagram representing a method for generating a headshot, according to the present disclosure;

FIG. 5 is a photograph that illustrates an exemplary system for hanging and supporting a backdrop that includes a horizontal crossbar spanning between two support stands;

FIG. 6 is a photograph that illustrates an exemplary system for attaching a horizontal crossbar to a support stand in order to provide support to a backdrop;

FIG. 7 is a photograph that illustrates another exemplary method of supporting a horizontal crossbar to a support stand in order to provide support to a backdrop;

FIG. 8 is a photograph showing an acrylic tube to which a backdrop may be attached for convenience of storage, shipping, and general use;

FIG. 9 is a photograph showing an exemplary horizontal crossbar that can be used to support a backdrop;

FIG. 10 is a photograph showing an exemplary bottom weight and clip for hanging a backdrop as shown in FIG. 5;

FIG. 11 is a photograph that illustrates an exemplary system for attaching a backdrop to an acrylic tube like that shown in FIG. 8 and for hanging and supporting the backdrop from a horizontal support as shown in FIG. 5;

FIG. 12 is a photograph showing a closeup view of the exemplary system shown in FIG. 11, wherein a backdrop is attached to an acrylic tube by means of a strip of hook and loop fastener; and

FIG. 13 is a photograph illustrating a method for stowing a backdrop during storage or shipping that includes a packaging tube.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed invention. In addition, the terminology used herein is for the purpose of describing the embodiments, and is not necessarily intended to limit the scope of the claimed invention.

Bokeh photography has become popular among professional photographers, in which photographers capture subjects with “wide open” camera systems, using the widest apertures available for their lenses to intentionally blur the background. A blurry background is generally viewed as visually pleasing and evidence of professionalism, in particular because “wide open” lenses that allow for large apertures (e.g., f/2.8 or f/2.0 or lower) are relatively expensive. Typical consumer cameras are “closed down” camera systems with much smaller apertures, such as f/8 or f/12 apertures. Use of a smaller lens aperture, however, results in an in-focus background, which can distract from the subject of the portrait.

Considerable time and care are necessary to effectively capture a bokeh photograph with a “wide open” camera system, whereas capturing with a “closed down” camera system can be accomplished relatively quickly. If a photographer fails to take the time to find the correct balance between aperture size, focal length, distance between the subject, the camera, and the background, etc., the resulting portrait might be improperly focused (e.g., front-focused on the subject's nose or back-focused on the subject's ears).

Bokeh photography is thus viewed as impractical for high-volume photography engagements, such as trade shows, corporate photography events, or other educational or social events. At such events, photographers are unable to allocate a sufficient amount of time for each subject and thus cannot capture an effective “wide open” photograph.

In addition, photographers often desire visually pleasing real backgrounds for headshots, such as a natural outdoor environment, a majestic building lobby, or a cityscape etc. Such real environments often prove impractical because it is undesirable to expend time and resources to relocate subjects to real environments. Also, real photographic environments are subject to natural changes in lighting and weather.

In some instances, photographers utilize a large printed backdrop of a visually pleasing environment. Such backgrounds, however, often appear fake, especially to those skilled in photography.

A green screen setup is sometimes utilized, and the photographer manipulates the captured portraits (e.g., via computer post-processing) to place the subjects in a realistic environment after capturing the portraits. The computer post-processing necessary for this approach, however, is often lengthy, and the use of a green screen for portraits is easily discernible, particularly around the subject's hair.

The systems and methods of the present disclosure include steps for generating a headshot. Certain embodiments of the methods include arranging a diffuse light system by positing a first light source to emit light toward a scattering layer including a white surface such that the emitted light reflects diffusely off of the scattering layer. The method also includes positioning a background layer made of translucent material such that diffuse light from the diffuse light system at least partially transmits through the background layer, wherein the background layer has disposed thereon a bokeh background image, and wherein the bokeh background image is illuminated by the diffuse light. Furthermore, a step of arranging a subject lighting system to illuminate a subject positioned proximate to the background layer is included. Finally, the method includes capturing a photograph of at least a portion of the subject and the bokeh background image with a camera.

Aspects of the disclosed embodiments allow photographers to utilize relatively small aperture camera systems to capture portraits that convincingly and believably appear to have been captured with a “wide open” camera system (utilizing traditional bokeh photography methods) in front of a real background (e.g., a natural environment). Some aspects of the disclosed embodiments provide for a portable and compact background system, thus avoiding the problems associated with capturing subjects in front of a real environmental background. Further, some aspects of the disclosed embodiments make each captured portrait usable as-is, thus eliminating the need for computer post-processing associated with green screen systems. Certain aspects of the disclosed embodiments may render the embodiments particularly beneficial in the context of high-volume photography engagements.

Various embodiments of the systems and methods for generating a headshot of the present disclosure will now be described.

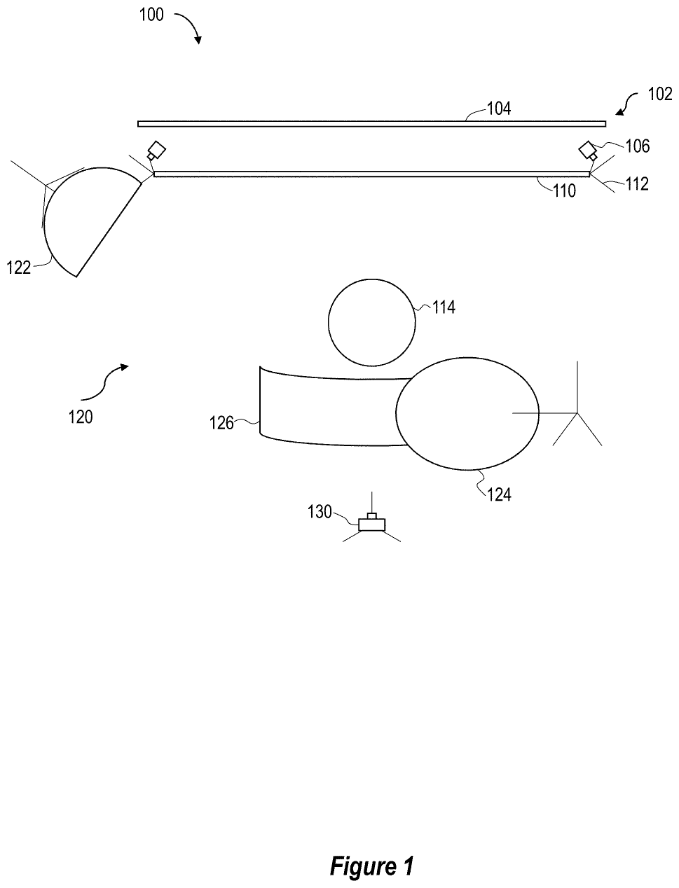

FIG. 1 illustrates a schematic representation of an exemplary system 100 for generating a headshot. The system 100 includes a diffuse light system 102, a background layer 110, a subject lighting system 120, and a camera 130.

The diffuse light system 102 includes a scattering layer 104 and a light source 106. The scattering layer 104, in some embodiments, includes a white surface composed of any material with properties that will cause light directed at the white surface to be scattered (e.g., reflected diffusely) rather than undergo specular reflection. As used herein, the term “white surface” comprises any true white or near white surface that will not substantially alter the hue of a light source being reflected there off. For example, in some instances the scattering layer 104 is embodied as a portable white backdrop. In other instances, the scattering layer 104 is implemented as a painted white wall. In yet other instances, the scattering layer 104 is embodied as white fabric.

In some embodiments, the light source 106 of the diffuse light system 102 is implemented as one or more spotlights situated to direct white light toward the scattering layer 104, such that the white light emitted from the light source 106 reflects diffusely off of the scattering layer 104 to generate diffuse light.

In the illustrated embodiment, the spotlight(s) of the light source 106 of the diffuse light system 102 are positioned between the scattering layer 104 and the background layer 110 and are directed toward a front surface of the scattering layer 104 for diffuse reflection (i.e., front from the perspective of the camera 130). However, those skilled in the art will appreciate that the light source 106 of the diffuse light system 102 may, in some embodiments, be positioned behind the scattering layer 104 on a side opposite the background layer 110, and directed toward a back surface of the scattering layer 104. In such alternative embodiments, the scattering layer 104 will be composed of a material through which the light emitted by the light source 106 may transmit (e.g., white fabric). Accordingly, the white light emitted from the light source 106 will transmit diffusely through the scattering layer 104 to generate diffuse light.

Furthermore, in the illustrated schematic representation of FIG. 1, the spotlight(s) of the light source 106 are affixed to and supported by mounting frame 112 of the background layer 110. In some embodiments, such a configuration reduces the number of supports required in system 100, since the mounting frame 112 secure both the background layer 110 and the light source 106 of the diffuse light system 102. However, it will be appreciated that other mechanisms for supporting the spotlight(s) of the light source 106 of the diffuse light system 102 are within the scope of the present disclosure, such as affixing the spotlight(s) to the scattering layer 104 or supports of the scattering layer 104, or utilizing independent stands/supports for the light source 106.

The diffuse light generated by the diffuse light system 102 is, in some embodiments, directed toward a back side of the background layer 110. Accordingly, the diffuse light system 102 is configured to output light so as to sufficiently illuminate the background layer 110, from the perspective of camera 130. For example, in some embodiments, the diffuse light system 102 is configured to output 320,000 lumens, or output light at f/22, ISO 100, and shutter speed 200.

The background layer 110 will now be described in more detail. The background layer 110 is configured to provide a visual backdrop for a photographic session. Initially, the background layer 110 is composed of a translucent material, so as to permit the diffuse light from the diffuse light system 102 to at least partially transmit through the background layer 110. In some embodiments, the background layer 110 is implemented as a translucent glass, film, fabric, no stretch waterproof textile, and/or polymer (e.g., Duratrans).

The background layer 110 also includes a large-format image of an intentionally blurred representation of a real environment which will serve as the backdrop for the photographic session (e.g., a bokeh background image). In some embodiments, the large-format bokeh background image may be of a high-resolution photograph of any desirable real environment, such as a natural outdoor environment or vista, a majestic or spacious indoor environment, a nighttime cityscape, etc.

As noted, the bokeh image of the background layer 110 is illuminated (e.g., back-lit) by the diffuse light system 102 described above. The back-lit printed environment of the background layer 110 thus emulates the background of a photograph that was captured with a “wide open” camera system in the real environment (e.g., a traditional bokeh photograph). Therefore, because the background layer 110 is blurred and illuminated, a photographer may place a subject to be photographed at a subject position (e.g., subject position 114) in front of the background layer 110 and capture photographs of the subject in a controlled scenario (e.g., easily accessible, not subject to weather) with a “closed down” camera system (e.g., small aperture, such as f/8) while still conveying the illusion of a distant real background and convincingly providing the visually pleasing effects of bokeh photography with a “wide open” camera system (which can be further benefited if the photographer properly utilizes a subject lighting system 120, as described below).

Thus, the properly illuminated bokeh background layer 110 allows photographers, in some instances, to circumvent the problems associated with attaining the aesthetically pleasing effects of “wide open” photography in real environments. These aspects of the disclosed invention may make it possible for photographers to provide quality bokeh-style photographs in high-volume photography settings, in part because travel to desirable locations/environments is unnecessary, and the photographer can utilize small aperture lenses, which require less time to capture a usable photograph than large aperture lens systems.

Additionally, the systems described herein enable portability and dynamic implementation, allowing the photographer to quickly and easily set up the disclosed system in many varying environments and within a matter of minutes. This is a significant improvement over other photographic systems. For example, the photographer does not need to have the disclosed system permanently established within a static, controlled environment. Rather, the system is designed to enable utility within many varying environments and can beneficially allow the subject to be placed in a variety of realistically-appearing backgrounds without leaving the portable set.

Because the background layer 110 includes the bokeh background image which serves as the backdrop for a photography session, it is desirable that the background layer be as flat as possible and be free of wrinkles and folds. Accordingly, in some embodiments, the background layer 110 is composed of a material that is at least partially rigid (e.g., a rigid polymer), so as to prevent wrinkling. A rigid printed background layer 110, however, may not be easily collapsible and/or transportable. Thus, in some embodiments, the background layer 110 is made of a material that can be rolled, folded, or otherwise compressed into an easily transportable unit (e.g., a fabric, such as Ultra Flexx d270, a waterproof textile with no stretch, a flexible polymer, or a film, such as Duratrans).

In embodiments where the background layer 110 is composed of a flexible material, the mounting frame 112 of the background layer may include a tensioning system for pulling the background layer 110 into a flat position. For example, in some embodiments, the mounting frame 112 includes rails to which the background layer 110 may be selectably affixed and spring biasing members for pulling on the rails to secure the background layer 110 in a flat position. In another example, the mounting frame 112 comprises a spring-loaded roller system with the background layer 110 disposed inside (similar to a projector screen or map roller system), wherein the background layer 110 may be drawn/pulled out of the roller system, and an end of the background layer 110 may be connected to a mounting structure to secure the background layer 110 in a tensioned position. In yet another embodiment, the background layer 110 may be affixed to an acrylic tube at an upper end, and a bottom weight may be affixed to a lower end to allow for the background layer 110 to be hanged from and supported by a mounting frame 112 that includes vertical supports and a horizontal crossbar.

Those skilled in the art will recognize that the mounting frame 112 may be configured to tension the background layer 110 in the vertical direction, the horizontal direction, or both. Furthermore, it will be appreciated that the mounting frame may include or be attached to a stand for suspending the mounting frame above the ground (e.g., a c-stand), and that the height of such stands and/or the mounting frames 112 may be adjustable according to the desired vertical position of the background layer 110. By way of non-limiting example, the mounting frame 112 may be embodied as a spring-loaded roller system which is attached to a vertically adjustable c-stand, such that the background layer 110 is drawn from the roller system horizontally and secured to a mounting structure on an opposing vertical c-stand. In another example, the mounting frame 112 includes a spring-loaded roller system which is attached to a vertically adjustable stand such that the background layer 110 is drawn from the roller system vertically and secured to a mounting structure on the same adjustable stand.

It will be appreciated that the background layer 110 is of a sufficient size to provide a full or partial background for a subject position 114 located in front of the background layer 110. In some embodiments, the background layer 110 is 63 inches wide and 42 inches tall. Other sizes are within the scope of this disclosure, as required by the circumstances of implementation.

The subject position 114 may be located in front of the background layer 110, as noted above. When a photograph of the subject within the subject position 114 is captured with a small aperture lens, the subject will appear to be located within the real environment represented by the intentionally blurred image disposed on the background layer 110, and the image will appear to have been captured with a large aperture lens utilizing traditional bokeh photography methods. This allows a photographer greater flexibility when choosing a focal point for the image and even allows for auto-focusing techniques to be implemented without a substantial loss in image fidelity.

In some embodiments, the subject position is a few feet from the background layer 110, which is beneficial in situations where space is limited (e.g., at a trade show or business event). Because the backdrop of the background layer 110 is blurred, the resultant portrait will still give the backdrop the appearance of a distant environmental background.

FIG. 1 further illustrates a subject lighting system 120. In the exemplary illustrated embodiment, the subject lighting system 120 includes a rim light 122, a front light 124, and a reflector 126. In order for the photographs captured with the system 100 to convincingly demonstrate the qualities commonly found in bokeh photography, it is desirous that the subject appear as though it is under lighting conditions that are similar to the lighting conditions of the real environment represented in the bokeh background image of the background layer 110. This can be accomplished, for example, by the subject lighting system 120, which is arranged to emulate the lighting conditions of the backdrop of the background layer 110.

Accordingly, in some embodiments, such as the embodiment illustrated in FIG. 1, the subject lighting system 120 includes a rim light 122 (sometimes referred to as a kicker or accent light). Because the illuminated environment of the background layer 110 is placed behind the subject position 114, it follows that if the subject (positioned at the subject position 114) were placed in a real environment similar to the illuminated environment, light from the real environment would be cast over the back and/or sides of the subject and accentuate certain features of the subject, such as the subject's shoulders, neck, jaw, and/or hair. In at least some implementations, the diffuse light from the diffuse light system 102 that transmits through the background layer 110 will be insufficient to accentuate the subject 114's features in a convincing way. Therefore, in some embodiments, a rim light 122 is placed laterally offset from and/or behind the subject, as illustrated in FIG. 1. The rim light 122 serves to accentuate the features of the subject so as to emulate the environmental light that would be cast on the subject if the subject were located in the real environment represented by background layer 110.

In some instances, the rim light 122 is embodied as a softbox light with a grid structure to prevent light spilling. In other embodiments, the rim light 122 is implemented as a bare head light, speed light, or other light system, optimized to prevent light spilling.

It will be appreciated that while the rim light 122 is illustrated on the left side of and behind the subject 114, other locations for the rim light 122, as well as other quantities of rim lights (e.g., two or more), are within the scope of this disclosure. In some embodiments, the location and/or luminosity of the rim light 122 will depend on the original lighting of the environment represented in the background layer 110. For example, if the environment represented in the background layer 110 is of a spacious building lobby with a primary light source in the rear-right portion of the lobby, a rim light 122 will be placed on the right side of and behind the subject position 114.

The subject lighting system 120 of the embodiments illustrated in FIG. 1 further includes a front light 124 and a reflector 126. In some embodiments, the front light 124 and the reflector 126 are provided to emulate other light sources of the environment represented in the background layer 110. Accordingly, in some instances, the front light 124 and reflector 126 serve to illuminate the subject 114 such that the resultant portraits of the subject 114 believably convey that the portraits were captured using traditional bokeh photography methods while the subject 114 was located within the real environment represented by the background layer 110.

It will be appreciated that the subject lighting system 120 represented in FIG. 1 is non-limiting and exemplary. For instance, subject lighting systems 120 that do not include a reflector or rim light, or that include more than one reflector, more than one rim light, more than one front light (e.g., an upward-tilted front light in lieu of a reflector), or additional lighting structures (e.g., a hair light) are within the scope of this disclosure. Those skilled in the art will recognize that the particular details of the subject lighting system 120 selected may depend at least in part on the lighting conditions of the blurred environment represented on the background layer 110. For example, a subject lighting system may be configured to output 160,000 lumens, or output light at f/16, ISO 100, and shutter speed 200.

The exemplary illustrated embodiment is arranged for capturing a headshot of a single, human subject, but those skilled in the art will recognize that other subject lighting arrangements are within the scope of this disclosure. For example, if multiple subjects will be captured, an elongated reflector may be utilized, and/or an alternative front light structure.

Also represented in FIG. 1 is a camera 130. Because the background layer 110 includes a large-format image of an intentionally blurred representation of a real environment, a camera with a relatively small aperture (e.g., f/4 to f/22) may be utilized to capture a photograph of the subject 114. In some embodiments, the small aperture ameliorates the risk of improper focus (e.g., front-focus or back-focus) when capturing the photograph, and thus reduces the time needed to capture a usable portrait of the subject 114. The shorter time requirement allows photographers, in some embodiments, to capture headshots with a small aperture (e.g., f/8) in high-volume engagements and in compact settings (e.g., at a trade show or business event) that give the illusion of “wide open” photography (e.g., f/1.4, f/2, or f/2.8) at a visually appealing real location. Additionally, in some implementations, the photographs captured by camera 130 are immediately usable without computer post-processing.

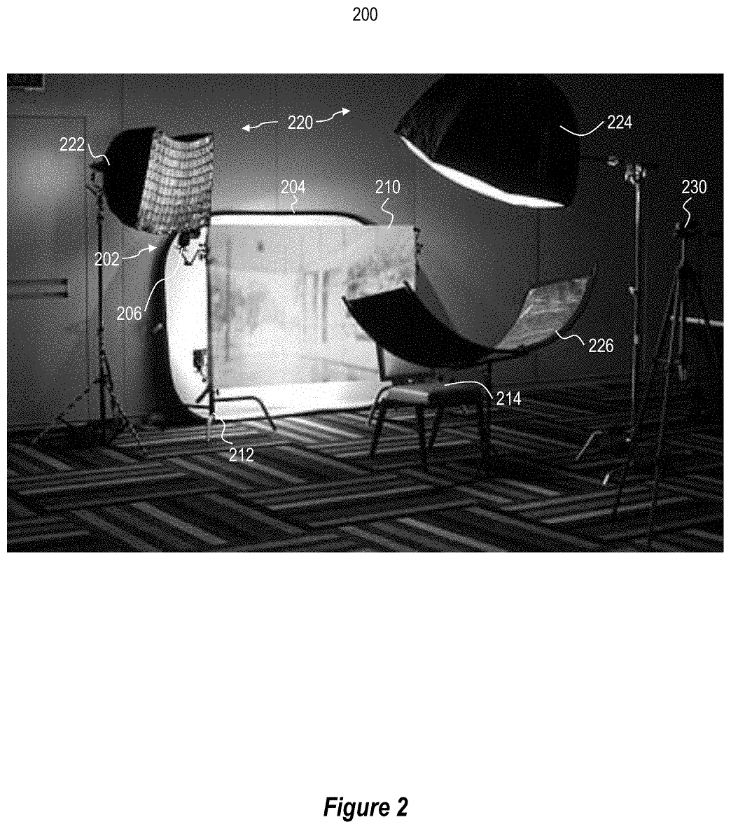

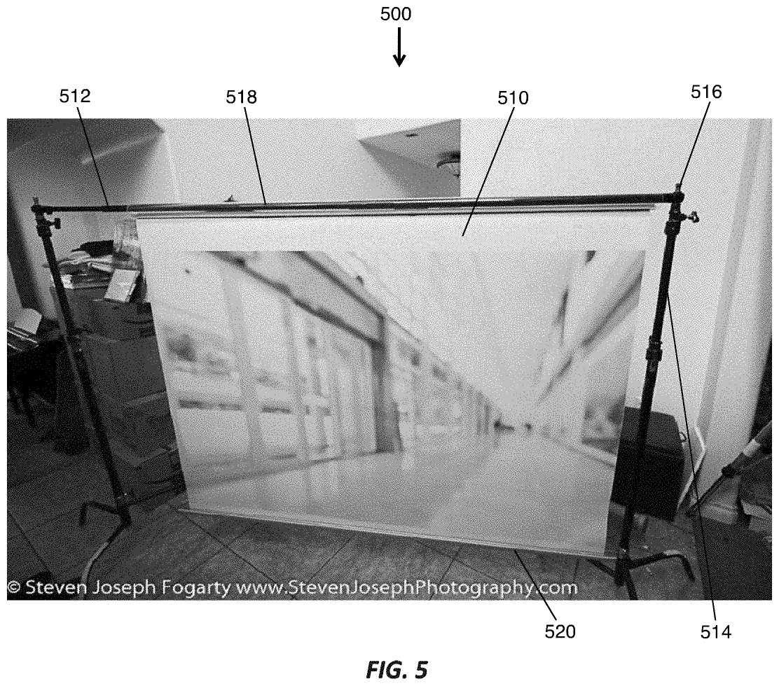

FIG. 2 illustrates a photograph of an exemplary implementation of a system 200 for generating a headshot, according to the present disclosure. As shown, the diffuse light system 202 includes a scattering layer 204, which comprises a portable white backdrop, and a light source 206 which comprises multiple spotlights directed at the front side of the scattering layer 204. The system 200 also includes a background layer 210 implemented as a Duratrans print with a large-format bokeh image of a spacious building lobby printed thereon. The background layer is supported by a mounting frame 212 which includes c-stands and gripping devices for holding the Duratrans layer in place. (Additional embodiments of systems used to grip and support background layer 210 in a desired position are discussed below with respect to FIGS. 5-12). The system 200 furthermore includes a subject position 214 (illustrated as a seat) for a subject (not shown) to pose in, and a subject lighting system 220 which includes a rim light 222 (shown as a softbox containing an egg crate grid), a front light 224, and a reflector 226. FIG. 2 also displays the camera 230 of system 200.

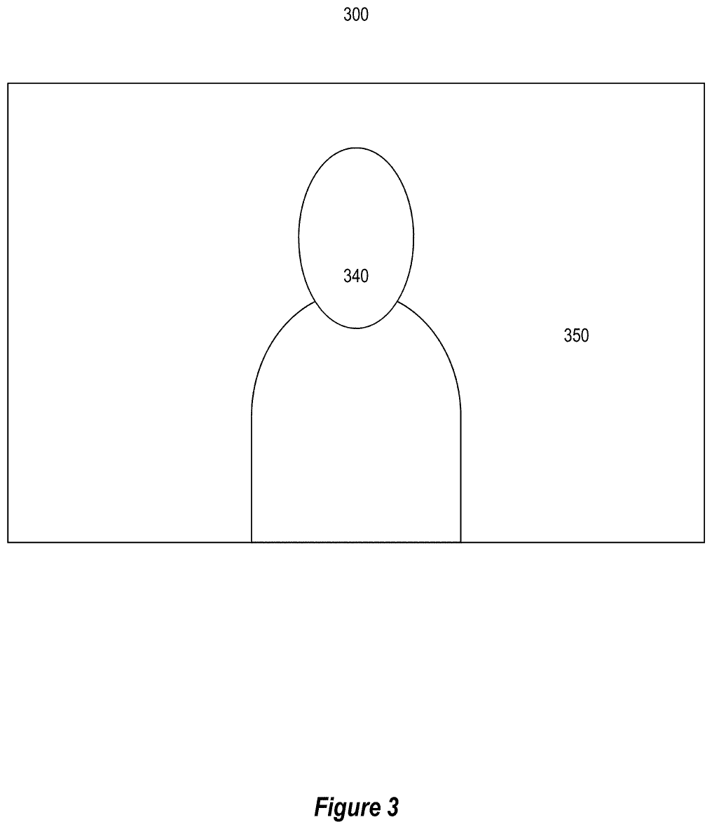

FIG. 3 illustrates a schematic representation of a headshot 300 generated according to at least some of the systems and methods of the present disclosure. The headshot 300 illustrates the subject 340, which is in focus as captured by a camera (e.g., camera 130) with a relatively small aperture (e.g., f/8). The headshot 300 also illustrates the photographic backdrop 350, which includes, for instance, a large-format bokeh image of a desirable photographic environment which is illuminated by transmitted diffuse light, such as described hereinabove in reference to background layer 110. Although the photographic backdrop 350 is technically in focus (as captured by a small aperture camera system), the photographic backdrop 350 still appears blurred because the image included in the photographic backdrop 350 is already intentionally blurred.

The subject 340 is also illuminated with a subject lighting system (e.g., subject lighting system 120) consistent with the lighting that would be cast on the subject 340 if the subject 340 were actually present in the environment represented in the photographic backdrop 350. Thus, the subject 340 of the headshot 300 appears in focus while the backdrop 350 appears out of focus, and the lighting of the subject 340 is consistent with the apparent lighting of the backdrop environment 350. Accordingly, the headshot 300 convincingly has the appearance of being captured “wide open” with a large aperture lens in a real environment, even though the headshot 300 was captured with a small aperture lens in front of a simulated back-lit backdrop 350.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

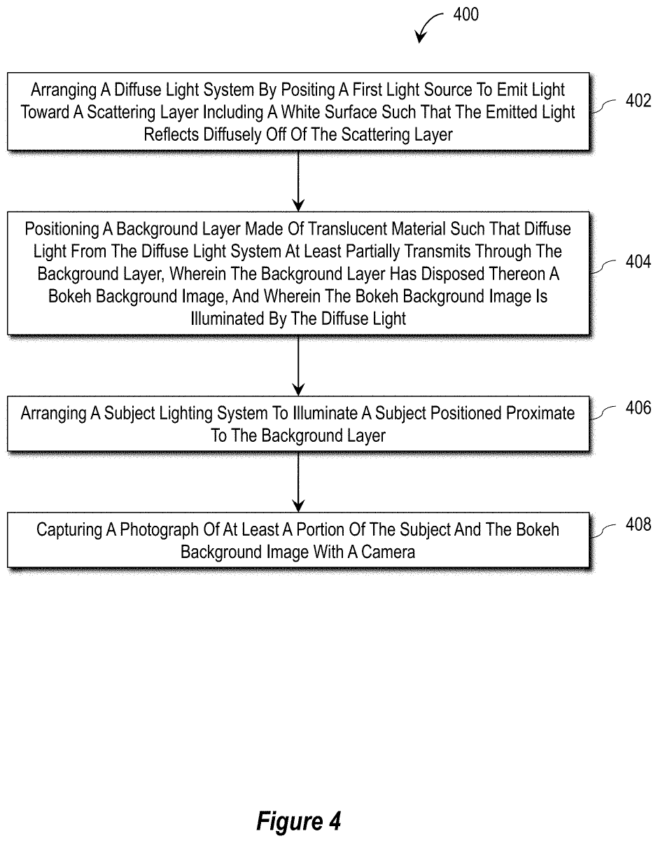

FIG. 4 illustrates a flowchart which represents an exemplary method 400 for generating a headshot. As shown, the flowchart includes steps of arranging a diffuse light system by positing a first light source to emit light toward a scattering layer including a white surface such that the emitted light reflects diffusely off of the scattering layer (step 402), positioning a background layer made of translucent material such that diffuse light from the diffuse light system at least partially transmits through the background layer, wherein the background layer has disposed thereon a bokeh background image, and wherein the bokeh background image is illuminated by the diffuse light (step 404), arranging a subject lighting system to illuminate a subject positioned proximate to the background layer (step 406), and capturing a photograph of at least a portion of the subject and the bokeh background image with a camera (step 408).

Step 402 of method 400 includes arranging a diffuse light system by positing a first light source to emit light toward a scattering layer including a white surface such that the emitted light reflects diffusely off of the scattering layer. In some embodiments, step 402 is carried out by affixing light source 106 to supports (such as mounting frame 112, supports of scattering layer 104, or other independent supports) and directing the light source 106 toward a front surface of scattering layer 104. The light from the light source 106 then reflects diffusely off of the scattering layer toward the background layer 110.

It will be appreciated that the light source 106 may, in some embodiments, be positioned behind the scattering layer 104 on a side opposite the background layer 110, and directed toward a back surface of the scattering layer 104. In such alternative embodiments, the scattering layer 104 will be composed of a material through which the light emitted by the light source 106 may transmit (e.g., white fabric). Accordingly, the white light emitted from the light source 106 will transmit diffusely through the scattering layer 104 to generate diffuse light.

Step 404 of method 400 includes positioning a background layer made of translucent material such that diffuse light from the diffuse light system at least partially transmits through the background layer, wherein the background layer has disposed thereon a bokeh background image, and wherein the bokeh background image is illuminated by the diffuse light. In some embodiments, step 404 is carried out by deploying background layer 110 with mounting frame 112 in close proximity and substantially parallel to the scattering layer 104 (e.g., within 2 feet) such that the diffuse light generated by the light source 106 and scattering layer 104 will at least partially transmit through the background layer 110 and illuminate the blurred image of the photographic environment disposed/printed on the background layer 110.

Step 406 of method 400 includes arranging a subject lighting system to illuminate a subject positioned proximate to the background layer. Step 406 is carried out, in some embodiments, by arranging elements described herein in relation to subject lighting system 120 (such as rim light 122, front light 124, and reflector 126, and other lighting elements, combinations, and arrangements described hereinabove) to illuminate a subject 114. In some embodiments, the selection, positioning, and lighting properties of the subject lighting system 120 are determined based at least in part on the lighting conditions that existed in the real environment represented in the bokeh background image of the background layer 110, such that the illumination of the subject 114 will be consistent with the illumination of the bokeh background image.

Finally, step 408 of method 400 includes capturing a photograph of at least a portion of the subject and the bokeh background image with a camera. A camera system 130 with a relatively small aperture (e.g., f/4 to f/22) is utilized for an easily focusable capture. Even though the entire resultant image is technically in focus, the bokeh background image of the background layer 110 will appear out of focus, because the backdrop disposed on the background layer 110 is already made intentionally blurred at the outset.

In some instances, the small aperture allows the photographer to spend less time capturing a usable portrait of the subject 114, and the bokeh background image of the background layer 110 allows the photographer to capture the subject 114 in such a way that the resultant photographs appear to have been captured utilizing traditional bokeh photography methods (e.g., a large aperture lens) in a real environment, even though the photographs are captured in a simulated environment (e.g., system 100).

FIG. 5 illustrates an exemplary system 500 for hanging and supporting a backdrop 510 that includes a horizontal cross bar 512 designed to support a weighted hanging backdrop 510. The horizontal crossbar 512 can be advantageously attached to a vertical support stand 514, such as a C-stand typically used in photography, using attachment means known in the art, such as by integrating the horizontal crossbar 512 with the male spigot 516 on top of a standard photography C-stand.

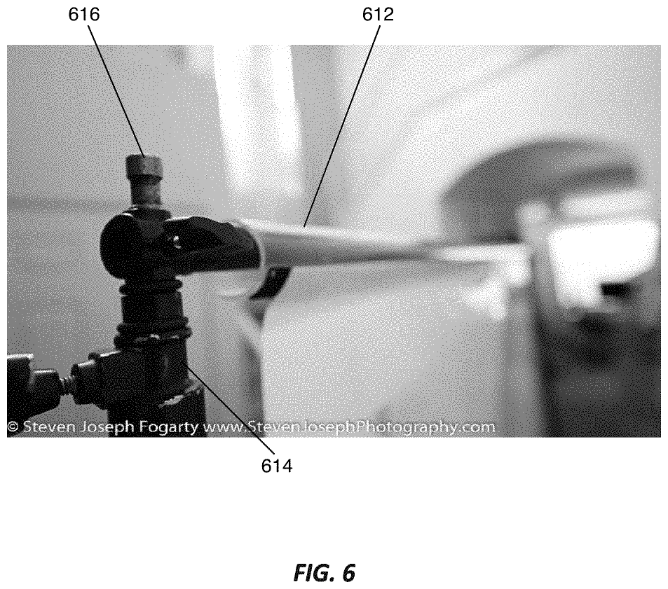

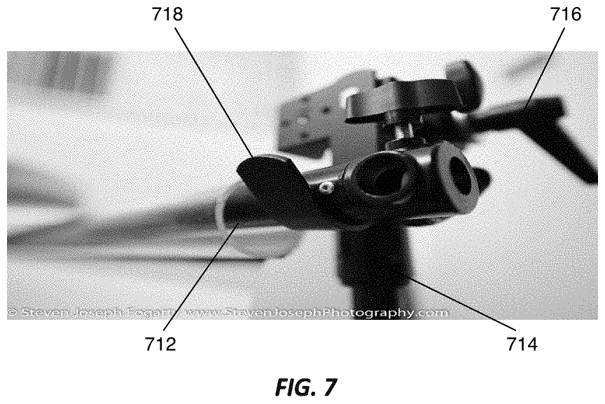

FIG. 6 shows a closeup view of a horizontal crossbar 612 attached to a vertical support stand 614. In this embodiment, an end of the horizontal crossbar 612 is integrated with the male spigot 616 on top of a vertical support stand 614. Alternatively, FIG. 7 shows a closeup view of a horizontal crossbar 712 attached to a vertical support stand 714 by cradling the horizontal crossbar 712 on a hook 718 or similar support that in turn is attached to the top of the vertical support stand 714 with a super clamp 716.

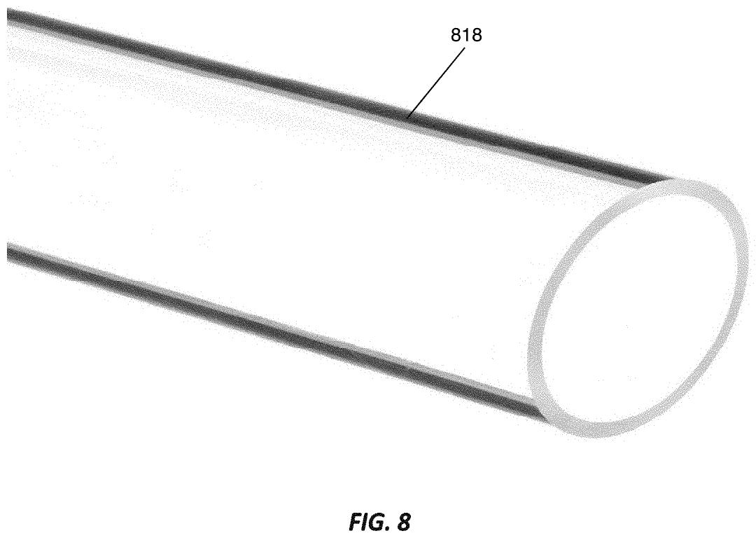

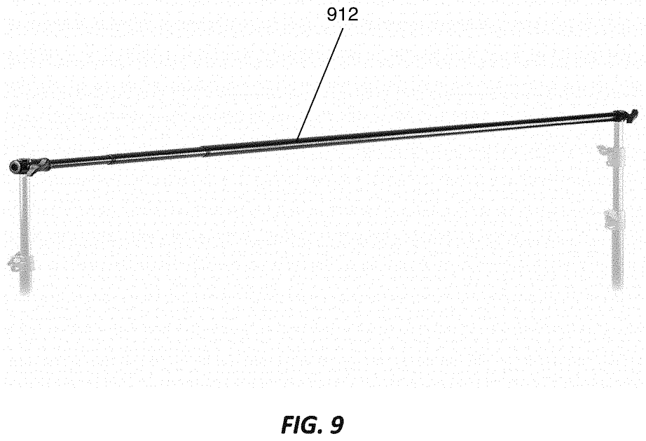

FIG. 8 shows an acrylic tube 818 that may be used to store and support a backdrop without damaging the printed image when the backdrop is rolled about the acrylic tube 818 for storage. FIG. 9 shows an exemplary horizontal cross bar 912 that may be used to support a backdrop. For example, the horizontal cross bar 912 may pass through the acrylic tube 818 of FIG. 8 to provide support to a backdrop attached to the acrylic tube 818.

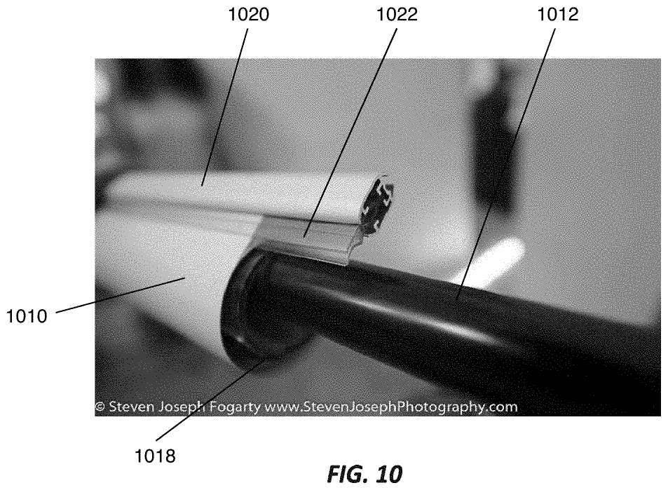

FIG. 10 is a closeup view a backdrop 1010 rolled onto an acrylic tube 1018, which in turn is supported by a horizontal cross bar 1012. In the embodiment shown, a bottom weight 1020 is attached to a lower end of the backdrop 1010 such that the backdrop 1010 will be held in tension when unrolled and hanged from the horizontal cross bar 1012. As illustrated, the bottom weight 1020 may be attached to the backdrop 1010 using a horizontal clip 1022 such as the plastic sleeve shown in FIG. 10. As an example, the bottom weight 1020 may include an AnoGotcha clip, which can be made of lightweight aluminum, and which is sold by Nova Display, Inc.

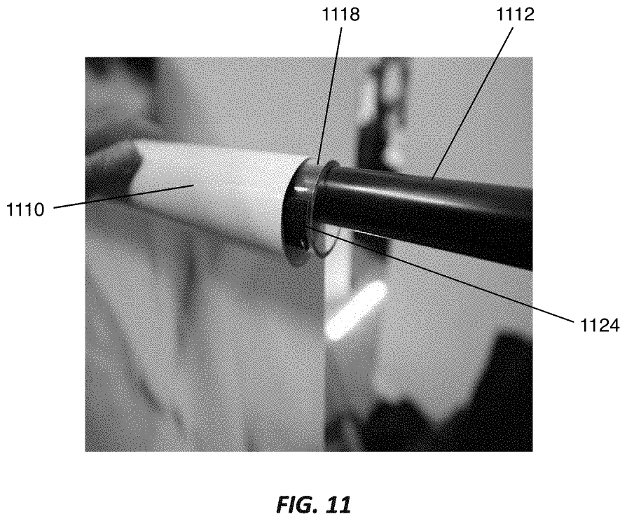

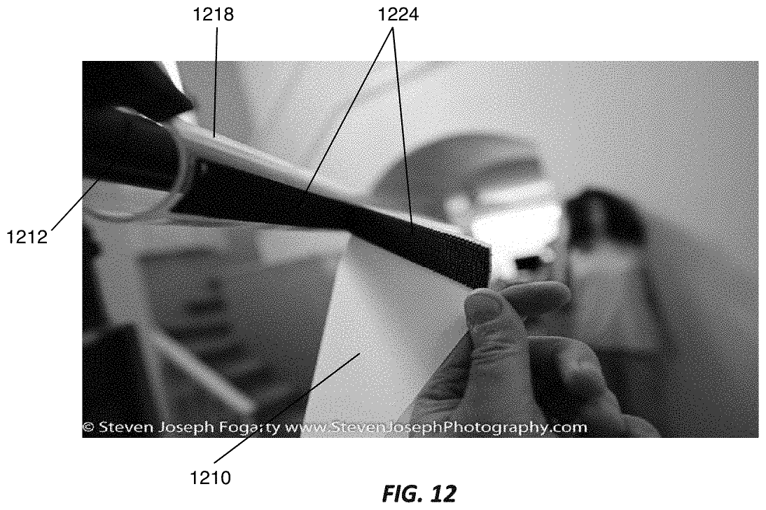

FIGS. 11 and 12 also illustrate a backdrop 1110, 1210 rolled onto an acrylic tube 1124, 1224 and supported by a horizontal cross bar 1112, 1212. Different means for attaching the backdrop 1110, 1210 to the acrylic tube 1124, 1224 include a strip of hook and loop fastener 1124, 1224 or other recloseable fastener that permits the backdrop to be selectively attached or detached from the tube. Alternatively, an adhesive strip would permit a more permanent connection to the tube. Where it is desired to switch out and replace one backdrop with another backdrop, such as where the first backdrop is damaged or where one or more other backdrops provide one or more alternative scenes, fasteners 1124, 1224 may be preferable. The portion of fastener 1124, 1224 attached to the roller can span any portion of the acrylic tube 1118, 1218 with the corresponding fastener being attached to the upper edge of the backdrop on its printed side. When a strip of fastener is adhered to the printed side of the backdrop 1110, 1210, a user may roll the backdrop about the acrylic tube 1118, 1218 such that the image printed on the backdrop is protected during storage and/or shipping.

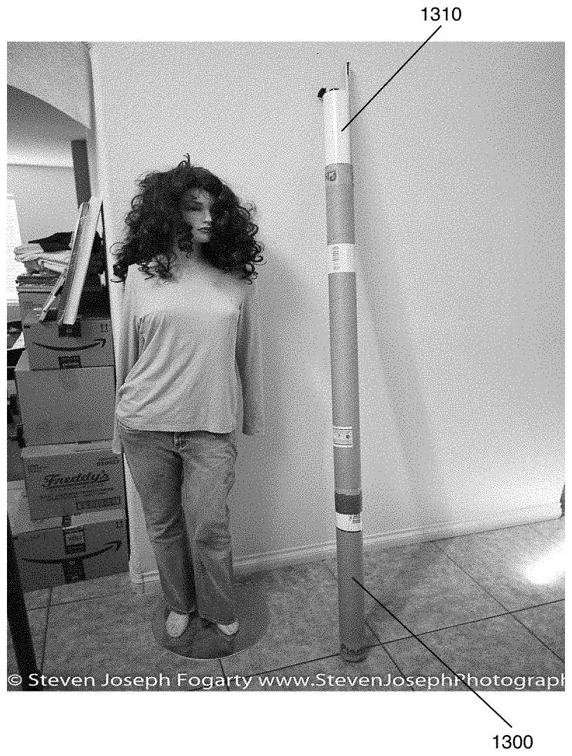

FIG. 13 illustrates a method for stowing a backdrop 1310 during storage or shipping that includes a packaging tube 1300. One example of a packaging tube 1300 is a standard cardboard shipping tube.

Following is an example of how the support system of FIGS. 5-12 can be used. If, for example, the backdrop image had dimensions of five feet high by seven feet wide, when attached to an acrylic tube or roller bar the backdrop can have a length of ten additional inches. In such case, the typical of the printed backdrop can be 5 feet 10 inches tall (sometimes referred to as the width, or shorter dimension) by 7 feet wide (sometimes referred to as the length, or longer dimension). The additional 10 inches of blank non-printed material can be used as slack, to be taken up and rolled over on the acrylic tube or roller bar. This provides greater adherence to the acrylic tube or roller bar. The long end of the fabric is adhered to the acrylic tube or roller bar using low-profile hook & loop Velcro-style strips. Adhering the printed material with hook & loop Velcro-style fastener allows the user to replace photographs and backdrops relatively easily. The current method used by map and shade manufacturers to adhere their products to the roller bar is permanent glue. A strong low-profile Velcro makes this roller bar, display and storage system much more flexible and useful to the consumer. And it allows the manufacturer to offer multiple backdrops to consumers, while requiring them to only buy one roller bar, display and storage system.

For example, a manufacturer may offer multiple backdrops displaying various images without the need to purchase additional hardware, such as the acrylic tube or roller bar and the support system discussed in reference to FIG. 5. Also, the manufacturer may offer printed backdrops that include any combination of the required parts for the system disclosed herein, and the consumer may swap out the backdrop images or other parts for replacement or alternative images or parts at their own discretion. As such, bokeh images of varying content and dimensions may be offered to consumers. The subject of such images include but are not limited to: foliage, a forest, a garden, shrubbery, a city skyline, a building lobby or other architectural feature, a desert cactus grove, a residential kitchen, a corporate lobby, a farm landscape, a mountain landscape, a meadow, a busy city street, or a famous location. The images purchased by the consumer may be stored in packaging tubes used to ship the materials, as discussed in reference to FIG. 13.

The backdrop can be rolled up on an acrylic tube or a typical map or blind spring-tensioned roller system. In practice there will be an extra 10 inches of unprinted material that rolls on to the roller bar. That extra material is fastened to the roller using a low-profile Velcro-style hook & loop, 3M style Dual Lock Reclosable Fasteners, or a similar fastening mechanism. This attachment system will allow the consumer to purchase and attach many different printed backdrops. This impermanent attachment system will allow the manufacturer to sell many different printed backdrops to consumers. The opposite side of the printed material can be stiffened and supported using a weighted rail attached to the bottom of the backdrop, such as the AnoGotcha holding rails from NovaDisplay discussed in reference to FIG. 10.

In one embodiment, the backdrop and roller system can be enclosed in a case made of metal or plastic that is both protective and promotional, providing space to print product information. The roller system and case may contain mounting systems typically used by photographers to attach things, such as ¼″ 20 thread bolts or female nuts/threads, or ⅜″ bolts or female nuts/threads, or other systems that allow a photographer to attach the backdrop to typical support systems used by photographers, such as C-stands.

Elements described in relation to any embodiment depicted and/or described herein may be substituted for or combined with elements described in relation to any other embodiment depicted and/or described herein.

Reference has been made to the drawings to describe various aspects of exemplary embodiments of the invention. It is understood that the drawings are diagrammatic and schematic representations of such exemplary embodiments, and are not limiting of the present invention, nor are any particular elements to be considered essential for all embodiments or that elements be assembled or manufactured in any particular order or manner. No inference should therefore be drawn from the drawings as to the necessity of any element. In the foregoing description, numerous specific details are set forth in order to provide a thorough understanding of the present invention. It will be obvious, however, to one of ordinary skill in the art that the present invention may be practiced without these specific details. In other cases, well-known aspects of online shopping, consumer database analytics, consumer behavior predictions, and related devices and the like are not described in detail herein in order to avoid unnecessarily obscuring the novel aspects of the present invention.

What is claimed is:

1. A system for generating a headshot, comprising:
a diffuse light system, comprising:
a scattering layer including a white surface; and
a first light source directed toward the scattering layer such that light emitted from the first light source reflects diffusely off of the scattering layer;
a background layer made of translucent material, wherein the background layer has disposed thereon a bokeh background image, and wherein diffuse light from the diffuse light system at least partially transmits through the background layer so as to illuminate the bokeh background image;
a subject lighting system configured to illuminate a subject position, the subject lighting system positioned proximate to the background layer; and
a camera arranged to capture at least a portion of the subject position and the bokeh background image of the background layer.

2. The system of claim 1, wherein the first light source is directed substantially away from the background layer.

3. The system of claim 1, wherein the subject lighting system comprises:
a softbox;
a front light; and
a reflector.

4. The system of claim 3, wherein the softbox additionally comprises an egg crate grid.

5. The system of claim 3, wherein the softbox is positioned behind and to one side of the subject position.

6. The system of claim 3, wherein the front light is positioned above the subject location and directed toward the reflector.

7. A system for selectively erecting a background for photography, comprising:
a background in the form of a sheet, film or fabric;
a rollup device including an acrylic tube attached to a first side of the background;
an elongated clamp configured to grip a free end of the background when retracted from the rollup device;
means for attaching the rollup device to one or more vertical stands configured to hold the rollup device in a horizontal position; and
means for attaching the elongated clamp to a weight configured to apply tension to the background when the rollup device is held in the horizontal position.

8. The system of claim 7, wherein the background is detachable from the rollup device and interchangeable with additional backgrounds.

9. A method for generating a headshot, the method comprising:
arranging a diffuse light system by positing a first light source to emit light toward a scattering layer including a white surface such that the emitted light reflects diffusely off of the scattering layer;
positioning a background layer made of translucent material such that diffuse light from the diffuse light system at least partially transmits through the background layer, wherein the background layer has disposed thereon a bokeh background image, and wherein the bokeh background image is illuminated by the diffuse light;
arranging a subject lighting system to illuminate a subject positioned proximate to the background layer; and
capturing a photograph of at least a portion of the subject and the bokeh background image with a camera.

10. The method of claim 9, wherein the first light source is directed substantially away from the background layer.

11. The method of claim 9, wherein the subject lighting system comprises:
a softbox;
a front light; and
a reflector.

12. The method of claim 11, wherein the softbox additionally comprises an egg crate grid.

13. The method of claim 11, wherein the softbox is positioned behind and to one side of the subject position.

14. The method of claim 11, wherein the front light is positioned above the subject location and directed toward the reflector.
